(19) United States
(12) Patent Application Publication
(10) Pub. No.: US 2015/0051135 A1
(43) Pub. Date: Feb. 19, 2015

(54) FLUID BASED ON WATER WHICH IS ELECTROLYTICALLY TREATED IN AT LEAST ONE ELECTROLYSIS CELL AND USE OF THE SAME AS A CLEANING AND/OR DISINFECTION AGENT

(71) Applicant: pro aqua Diamantelektroden Produktion GmbH & Co KG, Niklasdorf (AT)

(72) Inventors: Robert Hermann, Oberaich (AT); Michael Schelch, Oberaich (AT); Wolfgang Staber, Bruck an der Mur (AT); Wolfgang Wesner, Wien (AT)

(21) Appl. No.: 14/387,757

(22) PCT Filed: Mar. 28, 2013
(86) PCT No.: PCT/EP2013/056671

§ 371 Date: Sep. 24, 2014

(30) Foreign Application Priority Data
Mar. 29, 2012 (AT) A50112/2012

(51) Int. Cl. C11D 1/65; C11D 17/06; C11D 17/00

(52) U.S. Cl. CPC C11D 1/65; C11D 17/0047; C11D 17/06
USPC 510/362

(57) ABSTRACT

A method for producing a cleaning and/or disinfecting water-based fluid, containing at least one cleaning and/or disinfecting substance with oxidative effect, characterized in that at least one fat-dissolving and/or lime-dissolving substance is added to the water in a dosing of, in total, at least 0.1 g/l of water, at least one salt from the group of citrates, acetates, tartrates or formates is used as lime-dissolving substance, at least one C14-C18 carboxylic acid or a sulfonate or a hydroxide is used as fat-dissolving substance, wherein the water is electrolyzed in an electrolysis cell having at least one diamond electrode.

The invention relates to a water-based fluid which is electrolytically treated in at least one electrolysis cell, such that at least one cleaning and/or disinfecting substance with oxidative effect is produced as electrolysis product. The invention also relates to a water-based fluid which has been electrolytically treated in at least one electrolysis cell and which, as electrolysis product, contains at least one cleaning and/or disinfecting substance. The invention also relates to a substance in tablet or powder form or in the form of liquid concentrate of this substance, suitable for dissolving in water, for production of a fluid cleaning and/or disinfection agent formed by electrolysis in at least one electrolysis cell. The invention also relates to a method for producing a water-based fluid which is electrolytically treated in at least one electrolysis cell, such that at least one cleaning and/or disinfecting substance with oxidative effect is produced as electrolysis product.

It is known from WO 2009/067 838 A2 to clean and to disinfect laundry, textiles, crockery, vehicles, floors and other surfaces, materials and objects using electrolyzed water by means of oxidative radicals, which are produced in an electrolysis cell with diamond electrodes. Conventional washing machines, dishwashers, floor cleaning machines or washing installations for vehicles are to be equipped with what are known as electrolysis generators, which have one or more electrolysis cells with boron-doped diamond electrodes, a heavy-duty pump, which in particular conveys up to 600 l/h at 4 bar pressure, a pressure regulation system with corresponding cocks and manometers, en electronic control unit, water lines, valves, a water storage tank, time-measuring clocks and timers and the like. The electrolysis generators are to be operated via the mains power supply. During operation, the pump, for example, is to pump 10 l of water per minute through the electrolysis cells equipped with diamond electrodes, wherein the water is electrolyzed and oxidative radicals are produced, which ultimately cause the cleaning and disinfection effect. The washing process is to take place as usual, but with water that contains the cleaning oxidative radicals, such that no washing powder or other cleaning agent is necessary. The water used for the electrolysis is normal mains water, to which NaCl is optionally added in a quantity from 0.5 g/l to 8 g/l.

However, the use of mains water/sodium chloride solutions gives a very limited field of use of the technology of the electrolytic production of cleaning and disinfection agents. With good disinfection capacity by the chlorine compounds produced during the electrolysis, in particular the fat solubility and capability of removing lime-containing deposits leave a lot to be desired. Higher chloride concentrations may lead to corrosion of metals, in particular at neutral or slightly acidic pH value. The pH value of an electrolyzed sodium chloride solution also is not optimal for all applications, and in particular protein-containing organic impurities are often more easily dissolved at higher pH values.

The object of the present invention is to provide an optimized fluid for electrolytic treatment in an electrolysis cell, in which fluid, following the electrolysis, substances that clean and/or disinfect particularly well are contained. The fluid cleaning and/or disinfection agent obtained by electrolysis is additionally to be safe for the environment, hardly corrosive, and is not to pose a health risk.

The stated object is achieved in accordance with the invention in that the fluid already has lime-dissolving and/or fat-dissolving properties before the electrolytic treatment, wherein the lime-dissolving properties are to be attributed to the fact that the fluid contains one or more of the anions constituted by citrate, acetate, tartrate or formate, and wherein the fat-dissolving properties are to be attributed to the fact that the fluid contains anions of higher carboxylic acids, in particular of saturated fatty acids C14 to C18, or sulfonate, in particular alkylbenzene sulfonate, or hydroxide, and that the fluid contains Na⁺ ions and/or K⁺ ions and/or NH₄⁺ ions and anions of at least one carboxylic acid and/or of carbonic acid and/or of at least one oxo acid, cations and anions, in each case in a total content of at least 0.1 g/l.

In particular, the fluid according to the invention additionally contains one or more of the anions constituted by carbonate, hydrogen carbonate, phosphate, hydrogen phosphate, sulfate, hydrogen sulfate or chloride.

In accordance with the invention, this base is also to be supplemented by further constituents for the respective use of the cleaning solution, for example by alcohols. In a preferred embodiment, the addition of all constituents of the cleaning agent is performed prior to the electrolysis.

In accordance with the invention the electrolytically treated fluid therefore contains at least one active oxygen compound from the group comprising peroxides, percarbonates, hydrogen percarbonates, peracids, salts of peracids, persulfates, persulfonates or perphosphates as electrolysis product(s) of one or more of the following anions: citrate, acetate, tartrate, formate, anions of higher carboxylic acids, in particular of saturated fatty acids C14 to C18, carbonate, hydrogen carbonate, phosphate, hydrogen phosphate, sulfate, hydrogen sulfate, sulfonates, in particular secondary alkyl sulfonates and alkylbenzene sulfonates, chloride or hydroxide, which were contained in the fluid in a total content of at least 0.1 g/l prior to the electrolytic treatment.

The substance according to the invention in tablet or powder form or in the form of fluid concentrate, suitable and intended for dissolving in water for production of a fluid cleaning and/or disinfection agent to be formed by electrolysis in at least one electrolysis cell, is characterized in that it has fat-dissolving and/or lime-dissolving properties, wherein the lime-dissolving properties are to be attributed to the fact that the substance contains one or more of the anions constituted by citrate, acetate, tartrate or formate, and wherein the fat-dissolving properties are to be attributed to the fact that the substance contains anions of higher carboxylic acids, in particular of saturated fatty acids C14 to C18, or sulfonate, in particular alkylbenzene sulfonate, or hydroxide, and that the substance contains Na⁺ ions and/or K⁺ ions and/or NH₄⁺ ions and associated anions of at least one carboxylic acid and/or of carbonic acid and/or of at least one oxo acid.

The method according to the invention for producing a water-based fluid which is electrolytically treated in at least one electrolysis cell is characterized in that Na⁺ ions and/or K⁺ ions and/or NH₄⁺ ions and associated anions of at least one carboxylic acid and/or of carbonic acid and/or of at least one oxo acid, cations and anions are added in a dosed manner to the water, in each case in a total quantity of at least 0.1 g/l.

Besides the production of active oxygen compounds with increased disinfection demand, chlorine compounds can be produced from chlorides by addition of sodium chloride, potassium chloride or ammonium chloride or hydrochloric acid and is an additional aspect.

In accordance with the invention, active oxygen compounds are thus formed during the electrolysis depending on the composition of the starting solution and, chemically considered, are peroxides, percarbonates, hydrogen percarbonates, peracids, salts of peracids, persulfates, persulfonates or perphosphates and mixtures thereof. Due to the attachment of the active oxygen (of the hydroxyl radicals formed at the anode) to the substances present in the starting solution, the substances contained in the starting solution are activated, such that a much-improved effect can be attained for the practical application. The active oxygen, which enters into a direct bond with the components of the cleaning solution, enables the fat-, lime- or protein-dissolving compounds to penetrate quickly into dirt layers, which can be broken down oxidatively. Impurities coated by organic compounds or biofilm, or also hydrophobic organic impurities which elude treatment with conventional cleaning agents are also made accessible in this way.

The advantage of the cleaning agent according to the invention compared with conventional cleaning agents, which are provided with oxidation power by addition of an oxidative component, lies in the fact that the molecules of the cleaning agent itself have oxidation power and, following breakdown, provide their fat- or lime-dissolving power immediately directly at the location of oxidation. At the same time, fat-dissolving peroxides penetrate more quickly into hydrophobic impurities and lime-dissolving peroxides penetrate more quickly into organic-mineral deposits so as to effectively provide their oxidation power there. Further carrier materials and stabilizers for the peroxo compounds are saved by the direct electrolytic production of the active oxygen components based on the active substances.

This invention can be applied in three forms. Firstly, finished fluids can be provided, which are activated by the user by electrolytic treatment prior to the application. Secondly, concentrates or powders or tablets for the production of the solutions to be electrolytically activated by the user can be provided. Thirdly, finished, activated solutions can be provided.

Further advantages will therefore emerge from the present invention for the distribution and storage capability of the products. Active oxygen compounds are capable of being stored to a limited extent, since they decompose over time, particularly under the action of moisture. Due to the activation according to the invention of the specially composed starting substance by the consumer, which takes place shortly before use, the base products, specifically powder, tablets, concentrates or also the finished starting solutions for the electrolytic production of the cleaning agent, can be stored practically without limitation.

Especially perphosphates, but also organic peracids, are short-lived such that, in spite of their advantages, they have not found any use in the production of conventional washing agents. Due to the invention, the broad application of this and other specially composed short-lived active oxygen compounds is made possible.

If, as in conventional washing agents, the oxidative properties and the emulsifying or dissolving properties are distributed among various molecules of the solution, the breakdown of impurities is thus significantly slower, or, in order to achieve the same washing power, a greater quantity has to be used. The use of cleaning and disinfection agents according to the invention therefore saves material and increases the cleaning speed. This makes the fluid according to the invention particularly suitable as a cleaning and/or disinfection agent for the use for cleaning surfaces at home (in the kitchen, bathroom and toilet), but also surfaces in trade and industry.

Further features, advantages and details of the invention will now emerge from the following description.

The invention concerns the production of a fluid cleaning and/or disinfection agent based on water, in particular softened water or water with low hardness. Mains water is suitable for producing cleaning and/or disinfection agents, that is to say water from the communal water supply. Any softening is preferably performed in a known manner by reverse osmosis or ion exchange. The term “softened water” is to be understood to mean water that has a hardness ≦4° dH (German degree of hardness), in particular ≦3° dH. The cleaning and/or disinfection agent according to the invention is particularly suitable for cleaning and/or disinfecting surfaces of all types, in particular smooth or largely smooth surfaces at home, in trade and in industry. The cleaning and/or disinfection agent according to the invention particularly also has a good fat-dissolving effect. In addition, an increased lime-dissolving effect and/or an increased disinfection effect can be attained.

The cleaning and/or disinfection agent according to the invention is produced from water with various additives, as is also described, by electrolysis in at least one electrolysis cell. Electrolysis products are produced in the water as a result of the electrolysis and have a cleaning, fat-dissolving, lime-dissolving, oxidative and/or a disinfecting effect.

The water to be electrolyzed contains Na⁺ ions and/or K⁺ ions and/or NH₄⁺ ions and anions of at least one carboxylic acid, and/or of carbonic acid and/or of at least one oxo acid, cations and anions, in each case in a total content of at least 0.1 g/l. The contained anions may be one or more of the anions from the following group: citrate, acetate, tartrate, formate, anions of higher carboxylic acids, in particular of saturated fatty acids C14 to C18, carbonate, hydrogen carbonate, phosphate, hydrogen phosphate, sulfate, hydrogen sulfate, sulfonate, in particular alkylbenzene sulfonate, chloride or hydroxide.

From the free possibility of combination of the specified anions and cations, a large number of substances can be considered, these substances being dissolvable in water for the production of the starting solution for electrolytic activation. By way of example (see the practical examples further below), the following are mentioned:
sodium hydrogen carbonate or potassium hydrogen carbonate, sodium carbonate or potassium carbonate, ammonium hydrogen carbonate and/or ammonium carbonate, potassium phosphate, sodium phosphate or ammonium phosphate, potassium sulfonate, sodium sulfonate or ammonium sulfonate, in particular potassium alkylbenzene sulfonate, sodium alkylbenzene sulfonate or ammonium alkylbenzene sulfonate, potassium salts, sodium salts or ammonium salts of tartaric acid or of acetic acid or of formic acid or of citric acid, potassium sulfate, sodium sulfate or ammonium sulfate or the respective hydrogen sulfates, the sodium salts, potassium salts or ammonium salts or hydrogen salts of sulfonic acids or of phosphoric acid, or also the addition of ammonium, potassium hydroxide solution or sodium hydroxide solution to the specified acids themselves.

In addition, at least one of the salts NaCl, KCl or NH₄Cl can be dissolved in water. If ammonium carbonate (NH₄)₂CO₃ or ammonium hydrogen carbonate, NH₄HCO₃, is dissolved for low-residue cleaning agents, the chlorine salt ammonium chloride, NH₄Cl, will thus also be added with increased disinfection demand; an optional excess of ammonia can result in a yet further improved fat-dissolving power.

The respective substance or a corresponding mix of a number of the mentioned compounds can be provided in powder form, in tablet form or as fluid concentrate, in each case with dosing instructions. These forms contain the mentioned or desired compounds in concentrations that permit comfortable dosing from 0.1 g/l to 30 g/l, particularly up to 10 g/l. It is possible to load these compounds up to saturation concentration, however a maximum quantity of in each case a total of 30 g/l is preferred.

Any substances that result in the increased cleaning power, oxidation power, disinfection power and degreasing are produced as electrolysis products by electrolysis of the fluid. To this end, the fluid is prepared in at least one electrolysis cell, for example conveyed through an electrolysis cell. The electrolysis cell can be structured in a manner known per se, and the electrodes thereof can consist in particular of iridium, iridium/ruthenium or platinum, wherein at least one of the electrodes, in particular the anode, is preferably a diamond electrode. For example, diamond electrodes are electrodes made of diamond particles doped with boron or are electrodes coated with boron-doped diamond. The electrolysis cell may also contain one or more bipolar electrodes made of the mentioned materials. The electrolysis cell may be a flow-through cell, in which the fluid is conveyed in a manner assisted by an electrically operated pump.

Depending on the composition of the starting solution, active oxygen compounds are formed during the electrolysis and, chemically considered, are peroxides, percarbonates, hydrogen percarbonates, peracids, salts of peracids, persulfates, persulfonates or perphosphates and mixtures thereof. Furthermore, hydrogen peroxide and optionally the disinfecting free chlorine compounds HClO, OCl⁻ and Cl₂ are formed.

One or more further substance(s) may additionally be added to the fluid intended for electrolytic treatment. These substances include, in particular, ammonia, alcohol, potassium hydroxide solution, sodium hydroxide solution or hydrochloric acid, furthermore sodium chloride, ammonium chloride or potassium chloride. These substances have certain cleaning effects known per se, some also have a lime-dissolving effect, wherein, during the electrolytic treatment, depending on the starting substance, an oxidative and therefore in particular disinfecting and bacteria-killing effect is also produced due to the formation of peroxides, peracids and the like. The additional substances are selected and the dosing thereof is selected and/or adapted depending on the use, whether as a glass-cleaning agent, as a toilet cleaner, as cleaning agent with particular fat-dissolving power and the like.

There are a number of possibilities for providing the fluid to the user or consumer before or after completed electrolysis. A preferred possibility is to provide spray bottles with incorporated electrolysis cells, which are already filled with the finished, mixed fluid. Such handheld spraying devices are known per se, for example a battery-operated handheld spraying device is known from WO 2009/155 545 A2 which comprises a fluid container, a spray head with a spray nozzle, an electrolysis cell positioned in the container, a small electric water pump and corresponding tubes as suction pipes and connection lines and also a battery and associated electrical connections, and also a finger trigger as electric switch and an electric controller. By pressing on the finger trigger, the fluid is transported through the electrolysis cell and is chemically cleaved as a result of the electrolytic processes taking place therein, which leads to the formation of the mentioned electrolysis products. The electrolyzed fluid is transported to the spray nozzle and can be sprayed onto the surface to be treated.

The fluid according to the invention not yet electrolyzed can also be provided in convenient structures, such as closable bottles, in order to refill spray bottles having an integrated electrolysis cell. Furthermore, the activation can be performed in a bottle with electrolysis cell, and the activated water can then be refilled into a spray bottle. Alternatively, it is also possible to provide at least some of the starting substances, as mentioned, in tablet or powder form or as fluid concentrate, such that the user or consumer can dissolve the starting substances in normal mains water in accordance with instructions. The fluid can then be filled for example into the spray bottle containing an electrolysis cell. A further possibility lies in providing the already electrolyzed fluid as cleaning and/or disinfection agent in appropriate structures, screwable containers, bottles or the like or in conventional spray bottles having merely a spray head.

The following practical examples explain preferred applications of the invention:

### PRACTICAL EXAMPLE 1

### Powder, Tablets or Concentrate for Producing a Floor-Cleaning Agent Activatable by Means of Electrolysis

The product, which is dissolved or diluted in softened water, contains sodium hydrogen carbonate or potassium hydrogen carbonate. Following electrolytic activation in different concentrations, the product is outstandingly suitable for the cleaning of surfaces, in particular when these are soiled by fats.

### PRACTICAL EXAMPLE 2

### Powder, Tablets or Concentrate for Producing a Glass-Cleaning Agent Activatable by Means of Electrolysis

The product, which is dissolved or diluted in softened water, contains ammonium hydrogen carbonate and/or ammonium carbonate. In addition, ammonia can be contained or added in the concentrate or the fluid to be electrolyzed in order to further increase the fat-dissolving power and to increase the pH value. Following electrolytic activation in different concentrations, the fluid is outstandingly suitable for the cleaning of glass and smooth surfaces, wherein, with excellent oxidative effect and outstanding fat-dissolving power, smears and scum caused by salt residues are simultaneously avoided. Optional solubilizers such as alcohol can also be added advantageously prior to the electrolytic activation.

### PRACTICAL EXAMPLE 3

### Powder, Tablets or Concentrate for Producing a Dishwashing Agent Activatable by Means of Electrolysis

The product, which is dissolved or diluted in softened water, contains potassium phosphates, sodium phosphates or ammonium phosphates or the analogous hydrogen phosphates for electrolytically forming the corresponding perphosphates. In addition, carbonates or hydrogen carbonates for forming percarbonates and hydrogen percarbonates can be contained.

### PRACTICAL EXAMPLE 4

### Powder, Tablets or Concentration for Producing a Textiles Washing Agent Activatable by Means of Electrolysis

The product, which is dissolved or diluted in softened water, contains potassium sulfonates, sodium sulfonates or ammonium sulfonates, in particular alkylbenzene sulfonates, for electrolytically forming the corresponding persulfonates. In addition, sodium, potassium or ammonium salts of long-chain fatty acids can be contained, which are partially converted into the corresponding percarboxylic acids by the electrolytic activation.

### PRACTICAL EXAMPLE 5

### Powder, Tablets or Concentrate for Producing a Descaler Activatable by Means of Electrolysis

The product, which is dissolved or diluted in softened water, contains potassium salts, sodium salts or ammonium salts of tartaric acid or acetic acid or formic acid or citric acid, which are partially converted into the corresponding peracids during the electrolytic activation. An excess of anions of the specified acids, or also of phosphoric acid or hydrochloric acid, makes it possible to provide an activatable, acidic, oxidative cleaning agent.

### PRACTICAL EXAMPLE 6

### Powder, Tablets or Concentrate for Producing a Washing Agent Activatable by Means of Electrolysis for Use at Increased Temperatures Above 50° C.

The product, which is dissolved or diluted in softened water, contains potassium sulfate, sodium sulfate or ammonium sulfate or the respective hydrogen sulfates, which are partially converted into the corresponding persulfates during the electrolytic activation. At room temperature, persulfates are so stable that a cleaning capacity or bleaching only starts at temperatures above 50° C.

### PRACTICAL EXAMPLE 7

### Modular System

A set of different powders, tablets or concentrates is offered, from which the user himself compiles the desired cleaning powers before he supplies the solution for electrolytic activation. A set of this type can consist for example of a basic cleaner (for example sodium hydrogen carbonate, potassium hydrogen carbonate or ammonium hydrogen carbonate), a fat dissolver (for example sodium (hydrogen) phosphate, potassium (hydrogen) phosphate or ammonium (hydrogen) phosphate), a lime dissolver (for example sodium acetate, sodium citrate or sodium tartrate, potassium acetate, potassium citrate or potassium tartrate, ammonium acetate, ammonium citrate or ammonium tartrate) and a disinfection component (sodium chloride, potassium chloride or ammonium chloride) (incomplete list).

1. A water-based fluid which is electrolytically treated in at least one electrolysis cell, such that at least one cleaning and/or disinfecting substance is produced as electrolysis product,
characterized in that
the fluid already has lime-dissolving and/or fat-dissolving properties before the electrolytic treatment, wherein the lime-dissolving properties are to be attributed to the fact that the fluid contains one or more of the anions constituted by citrate, acetate, tartrate or formate, and wherein the fat-dissolving properties are to be attributed to the fact that the fluid contains anions of higher carboxylic acids, in particular of saturated fatty acids C14 to C18, or sulfonate, in particular alkylbenzene sulfonate, or hydroxide,
and in that the fluid contains Na⁺ ions and/or K⁺ ions and/or NH₄⁺ ions and anions of at least one carboxylic acid and/or of carbonic acid and/or of at least one oxo acid, cations and anions, in each case in a total content of at least 0.1 g/l.

2. The fluid according to claim 1, characterized in that it additionally contains one or more of the anions constituted by carbonate, hydrogen carbonate, phosphate, hydrogen phosphate, sulfate, hydrogen sulfate or chloride.

3. The fluid according to claim 1, characterized in that the ions originate from one or more of the dissolved compounds constituted by sodium hydrogen carbonate or potassium hydrogen carbonate, sodium carbonate or potassium carbonate, ammonium hydrogen carbonate or ammonium carbonate, potassium phosphate, sodium phosphate or ammonium phosphate, potassium sulfonate, sodium sulfonate or ammonium sulfonate, potassium salts, sodium salts or ammonium salts of tartaric acid or acetic acid or formic acid or citric acid, potassium sulfate, sodium sulfate or ammonium sulfate or the respective hydrogen sulfates, or from potassium salts, sodium salts or ammonium salts of phosphoric acid, sulfonic acids, in particular secondary alkyl sulfonates and alkylbenzene sulfonic acids, or higher carboxylic acids (fatty acids, in particular C14-C18) or the corresponding free acids and lyes.

4. The fluid according to claim 1, characterized in that it contains Cl⁻ ions in a content of at least 0.1 g/l.

5. The fluid according to claim 3, characterized in that the Cl⁻ ions originate from dissolved NaCl and/or KCl and/or NH₄Cl.

6. The fluid according to claim 1, characterized in that one or more of the substances constituted by ammonia, alcohol, potassium hydroxide solution, sodium hydroxide solution or hydrochloric acid, sodium chloride, ammonium chloride or potassium chloride has/have been dissolved in said fluid.

7. A substance in tablet or powder form or in the form of fluid concentrate, which is dissolved or diluted in water, which is then electrolytically treated in at least one electrolysis cell, such that at least one cleaning and/or disinfecting substance is produced as electrolysis product,
characterized in that
said substance has fat-dissolving and/or lime-dissolving properties, wherein the lime-dissolving properties are to be attributed to the fact that the substance contains one or more of the anions constituted by citrate, acetate, tartrate or formate, and wherein the fat-dissolving properties are to be attributed to the fact that the substance contains anions of higher carboxylic acids, in particular of saturated fatty acids C14 to C18, or sulfonate, in particular alkylbenzene sulfonate, or hydroxide,
and in that the substance contains Na⁺ ions and/or K⁺ ions and/or NH₄⁺ ions and associated anions of at least one carboxylic acid and/or of carbonic acid and/or of at least one oxo acid.

8. The substance according to claim 7, characterized in that it additionally contains one or more of the anions constituted by carbonate, hydrogen carbonate, phosphate, hydrogen phosphate, sulfate, hydrogen sulfate or chloride.

9. The substance according to claim 7, characterized in that it contains the mentioned compounds in concentrations that permit a dosing from 0.1 g/l to 30 g/l, in particular up to 10 g/l.

10. The substance according to claim 7, characterized in that it contains sodium hydrogen carbonate or potassium hydrogen carbonate or sodium carbonate or potassium carbonate.

11. The substance according to claim 7, characterized in that it contains ammonium hydrogen carbonate and/or ammonium carbonate.

12. The substance according to claim 7, characterized in that it contains potassium phosphate, sodium phosphate or ammonium phosphate.

13. The substance according to claim 7, characterized in that it contains potassium sulfonate, sodium sulfonate or ammonium sulfonate, in particular potassium alkylbenzene sulfonate, sodium alkylbenzene sulfonate or ammonium alkylbenzene sulfonate.

14. The substance according to claim 7, characterized in that it contains potassium salts, sodium salts or ammonium salts of tartaric acid or acetic acid or of formic acid or of citric acid.

15. The substance according to claim 7, characterized in that it contains potassium sulfate, sodium sulfate or ammonium sulfate or one of the respective hydrogen sulfates.

16. A method for producing a cleaning and/or disinfecting water-based fluid, containing at least one cleaning and/or disinfecting substance with oxidative effect
characterized in that
at least one fat-dissolving and/or lime-dissolving substance is added to the water in a dosing of, in total, at least 0.1 g/l of water,
at least one salt from the group of citrates, acetates, tartrates or formates is used as lime-dissolving substance,
at least one C14-C18 carboxylic acid or a sulfonate or a hydroxide is used as fat-dissolving substance,
wherein the water is electrolyzed in an electrolysis cell having at least one diamond electrode.

17. The method according to claim 16, characterized in that alkylbenzene sulfonate is added to the water as lime-dissolving sulfonate.

18. The method according to claim 16, characterized in that one or more of the salts from the group of carbonates, hydrogen carbonates, phosphates, hydrogen phosphates, sulfates, hydrogen sulfates or chlorides is/are additionally added to the water.

19. The method according to claim 16, characterized in that at least one of the salts from the groups of sodium hydrogen carbonates or potassium hydrogen carbonates, sodium carbonates or potassium carbonates, ammonium hydrogen carbonates or ammonium carbonates, potassium phosphates, sodium phosphates or ammonium phosphates, potassium sulfonates, sodium sulfonates or ammonium sulfonates, potassium salts, sodium salts or ammonium salts of tartaric acid or acetic acid or formic acid or citric acid, potassium sulfates, sodium sulfates or ammonium sulfates or the respective hydrogen sulfates, secondary alkyl sulfonates or an alkylbenzene sulfonic acid, or at least one of the free acids or lyes corresponding to the salts is added to the water.

20. The method according to claim 16, characterized in that NaCl and/or KCl or NH₄Cl is additionally added to the water.

21. The method according to claim 16, characterized in that ammonia, alcohol, potassium hydroxide solution, sodium hydroxide solution or hydrochloric acid is additionally added to the water.

22. The method according to claim 16, characterized in that the fat-dissolving and/or lime-dissolving substances are added to the water in tablet form or powder form or in the form of liquid concentrate.

23. The method according to claim 16, characterized in that the fat-dissolving and/or lime-dissolving substances are added in a dosing of up to 30 g/l, in particular up to 10 g/l.
